(19) United States
(12) Patent Application Publication
(10) Pub. No.: US 2011/0181408 A1
(43) Pub. Date: Jul. 28, 2011

(54) Public Tactical Message System

(76) Inventors: Paul Gailey Greenis, Indian Harbour Beach, FL (US); William Russell Highsmith, Palm Bay, FL (US)

(21) Appl. No.: 13/015,373

(22) Filed: Jan. 27, 2011

Related U.S. Application Data
(60) Provisional application No. 61/299,021, filed on Jan. 28, 2010.

(51) Int. Cl. G08B 1/08

(52) U.S. Cl. 340/539.1

(57) ABSTRACT

An emergency message system provides localized tactical emergency messages to the public.

### CROSS-REFERENCE TO RELATED APPLICATIONS

Provisional Application No. 61/299,021, filed on Jan. 28, 2010

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of public safety communications. More particularly, the present invention is in the technical field of communication devices and services for road safety alerts to vehicles.

Prior Art: an automatic, impact or manually initiated, emergency signal generator that broadcasts a radio signal for guiding rescuers to a distressed vehicle (U.S. Pat. No. 6,324,393, issued Nov. 27, 2001, Doshay, Irving); The Emergency Alert System (EAS): www.fcc.gov/cgb/consuerfacts/eas.html (and links therein); ViaRadio: provides a means to create custom emergency messages and deliver them to receiving devices (generally in the home, business or institution) via a local FM radio.

The national Emergency Alert System (EAS) in the United States provides a mechanism for the President (via FEMA delegates), governors, and local officials to provide alerts to citizens via public radio broadcast stations. Some of these important alerts are quasi-real-time, such the Amber alert system for locating missing children, weather alerts, and traffic jams. However, some more real-time (tactical) situations, such as a fire truck approaching a particular traffic light, are not suitable for the EAS system because of the needed approval and content creation processes. The tactical situation would have expired before an EAS message could be broadcast. Further, tactical situations such as the example of an emergency vehicle approaching a traffic light typically have a small geographic scope. The EAS system handles national, state and local emergency events well, but a needed message, such as “fire truck approaching; pull over,” has no meaning or usefulness at those geographical scales.

First responders, such as fire, police an ambulance services have tactical communications within their respective services, but have no means to communicate with citizens in tactical situations other than sirens and limited-distance audio amplifiers. Similarly, state and national departments of transportation and counties have no means for tactical communications with citizens. For example, school buses, trains and subways have no means of communicating with citizens. In another example, state guards and the federal National Guard have no means of tactical communication with citizens.

Further, a system that requires major renovation to the existing EAS system or replacement of existing equipment would likely be rejected as economically impractical. Maximum re-use of existing equipment currently deployed to emergency workers and road travelers is needed.

Other prior art includes the ViaRadio alert system that provides a means for individuals and commercial interests to receive EAS-type messages via broadcast radio stations. This usefully extends EAS-type messages to citizens inexpensively and has a means of message creation, but has the same limitations described above with respect to the geographic scale of transmitted messages, and so is similarly unsuitable for tactical messaging.

What is needed is a means to enable field creation of local emergency alert broadcasts to improve public and first responder safety and efficiency.

### SUMMARY OF THE INVENTION

The present invention, Public Tactical Alert System, is a communication device and system for providing road safety alerts and information for drivers from field emergency workers. In the example of a speeding fire truck approaching a traffic light, a fireman presses a code on an alert transmitter module for a pre-configured (‘canned’) tactical emergency alert message (T-EAM) or uses a microphone connected to the alert transmitter module for an ad hoc T-EAM. The emergency alert transmitter module broadcasts the tactical emergency alert message locally over a designated radio frequency using the standard U.S. government EAS (Emergency Alert System) protocol or a similar protocol to an alert receiver module embedded in a receiving vehicle's AM/FM broadcast receiver. The alert receiver module overrides the AM/FM broadcast receiver's audio system and sounds and displays the tactical emergency alert messages. Similar example scenarios are evident for other public safety and first responder applications, such as police and ambulance/rescue vehicles approaching an incident or a traffic light.

Thus the present invention provides a means to supplement public emergency services with critically timely (tactical) alerts in a more selected or “surgical” area than is possible with national, state, regional, and county systems, such as the U.S. government's emergency alert system. The present invention uses much of the technology used in the emergency alert system to minimize the cost of deployment. An important enabler of the present invention is giving the T-EAM message sources more granular control of the geographic scale of the communications, so that, for example, only receivers near a particular traffic light or a city block hear the message. The minimum range for other alert communications systems is the range of a commercial FM or AM radio station, which typically serves a township or county. A non-obvious side benefit of the present invention is a limited form of interoperability among the various first responder and emergency services, as will be shown.

These preferred embodiments and other embodiments of the present invention are described in detail in the description herein below.

### BRIEF DESCRIPTION OF THE DRAWINGS

FIG. 1 is a block diagram of the preferred embodiment of the present invention;

FIG. 2 is a block diagram of the alert transmitter module of preferred embodiment of the present invention;

FIG. 3 is a block diagram of the alert receiver module of preferred embodiment of the present invention;

FIG. 4 is a diagram of the EAM and T-EAM message of the present invention;

FIG. 5 block diagram of an embodiment of the present invention to include Traffic Board support;

FIG. 6 is a block diagram of the alert receiver module traffic board embodiment of the present invention;

FIG. 7 is a diagram illustrating direction finding using LEDs;

FIG. 8 is a block diagram of the alert receiver module multicarrier embodiment of the present invention;

FIG. 9 is a block diagram of an agile frequency embodiment of the present invention;

FIG. 10 is a block diagram of moving vehicle containing an emergency transmitter module of an embodiment of the present invention;

FIG. 11 is a message filter of an embodiment of the present invention; and

FIG. 12 is a block diagram of an embodiment of the present invention using public broadcasting frequencies.

### DETAILED DESCRIPTION OF THE INVENTION

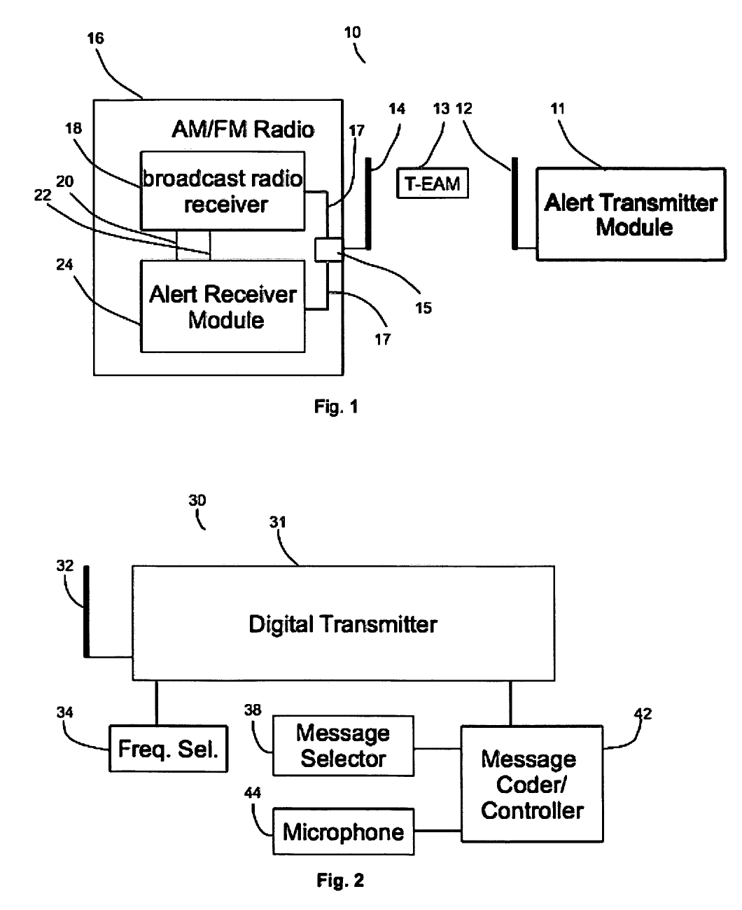

Referring now to the invention in more detail, in FIG. 1 there is an emergency alert system 10 having an alert transmitter module 11 which, in combination with an antenna 12, transmits tactical emergency alert messages (messages) 13 to receiver assembly 16 via antenna 14. Mobile receiver assembly 16 further includes a broadcast radio receiver 18, such as an AM/FM broadcast receiver (broadcast receiver), an alert receiver module 24, a receive RF signal divider 15, a control signal bundle 20 and a message signal bundle 22.

In more detail, still referring to the invention of FIG. 1, alert transmitter module 11, described in more detail later, provides an operator (not shown) a means (not shown) to select a canned message 13 or create an ad hoc message 13 and transmit it on a designated frequency for the tactical emergency alert system service. The message 13 would typically be a text message 13 or a digital voice message 13.

Antenna 14 of mobile receiver assembly 16 captures transmitted message 13 and other signals (not shown), such as broadcast AM or FM signals. RF signal splitter 15 splits the signal comprising message 13 and other signals (not shown), sending said signals to broadcast radio receiver 18 and alert receiver module 24 over RF signal line 17. Alert receiver module 24 decodes message 13. Using control signal bundle 20, alert receiver module 24 interrupts broadcast radio receiver 18 so that it will receive decoded message 13 over message signal bundle 22. Broadcast radio receiver 18 then interrupts any non-emergency signals (not shown) being displayed or played and displays text message 13 on a text display (not shown) on receiver assembly 16 and plays audio message 13 on a sound system (not shown) within receiver assembly 16.

As will be understood by one skilled in the radio art, the format of tactical emergency alert message 13 is exemplary. Standard message formats and proprietary message formats for conveying text and audio data is anticipated by the present invention.

Referring now to the invention shown in FIG. 2, there is an alert transmitter module, generally indicated by ‘30’, which includes a digital transmitter 31 used to transmit canned and ad hoc tactical alert messages (messages), not shown, to the alert receiver module 24 of FIG. 1. In FIG. 2, digital transmitter 31 transmits said messages via antenna 32. Alert transmitter module 30 further includes a frequency selection mechanism 34 that enables a user (not shown) to select a frequency for transmitting subsequent messages, such as keypad entry module (not shown) or other method well known to one skilled in the art. Alert transmitter module 30 further includes a message coder/controller 42 that digitally encodes a preselected text message (not shown) or preselected audio message (not shown) into a tactical emergency alert message (not shown) for transmission by digital transmitter 31. Alert transmitter module 30 further includes microphone 44 that enables an operator (not shown) to create an ad hoc audio message (not shown) for encoding by message coder/controller 42 into a tactical emergency alert message (not shown) for transmission by digital transmitter 31. Message selector 38 includes a circuit such as a keypad or other means well known to one in the art to enable an operator (not shown) to select one of the available predetermined (canned) messages. Similarly, message selector 38 may be integrated into microphone 44.

Still referring to FIG. 2, said canned messages may be represented and transmitted in multiple languages.

Still referring to FIG. 2, in another embodiment of the present invention, digital transmitter 31 is a transceiver. This added receiver functionality enables two-way management functions, such as the non-limiting example of uploading new firmware or software over the air. Similarly, said canned messages may be uploaded over the air for corrections, improvements and additions to the said canned messages. Uploading of canned messages and firmware also may be done via direct connection to the alert transmitter module 30 via Ethernet, USB connections and similar interfaces, as will be understood by one skilled in the art. As will be show below, having two-way communications enables more robust networking protocols, such as ad hoc networking and cognitive radio networking.

Still referring to FIG. 2, in another embodiment of the present invention, alert transmitter module 30 includes additional human interface elements that enable an operator to select a geographical area scale for subsequent transmitted messages, such as short, medium, and long distances from the location of the transmitting source of said messages. In a non-limiting example, ‘short’ may refer to a city block, ‘medium’ may refer to four city blocks, and ‘long’ may refer to a neighborhood. As will be understood by one skilled in the communications art, such distances are only approximate and would be controlled by attenuating the transmitter power of alert transmitter module 30 using an attenuator (not shown).

Still referring to FIG. 2, in another embodiment of the present invention, audio messages are coded using the AMBE coding standard, which is commonly used in emergency services equipment in the United States.

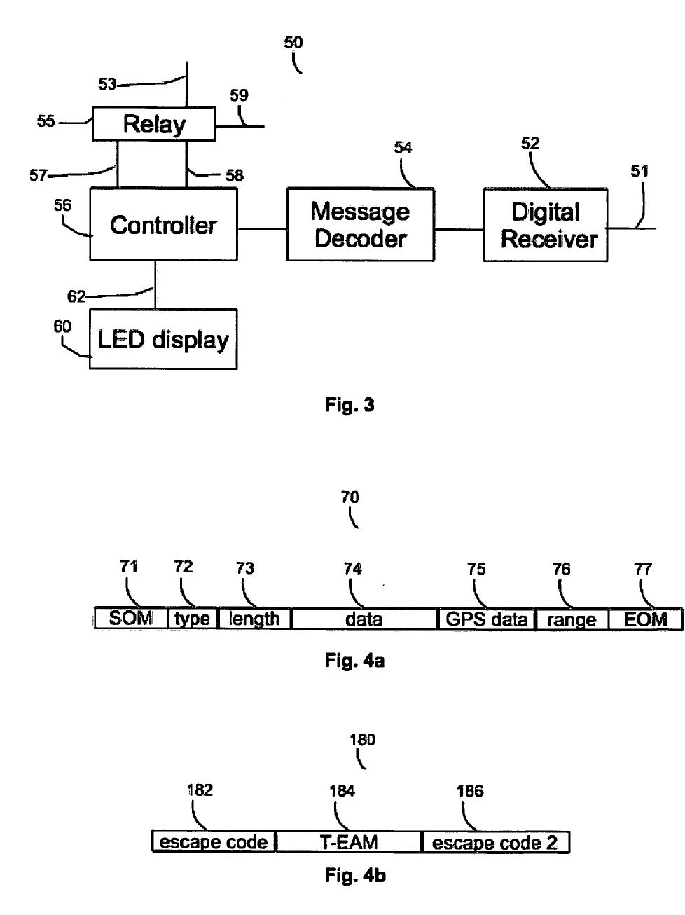

Referring now to the invention of FIG. 3, there is an alert receiver module 50 with an RF digital receiver 52 receiving an RF signal (not shown) over an RF signal line 51 from an antenna (not show) or signal splitter (not shown). Digital receiver 52 demodulates the RF signal and provides therefrom, in the present example, a demodulated digital audio signal stream to message decoder 54. Message decoder 54 decodes audio tactical emergency alert messages (not shown) from said demodulated digital signal stream and sends said audio tactical emergency alert messages to controller 56. Controller 56 sends said audio tactical emergency alert messages to relay 55 over message signal bundle 58. Relay 55 also receives the audio output 53 from broadcast radio receiver (not shown). During the presence of a said audio tactical emergency alert message, controller 56 switches relay 55 using control signal bundle 57 to relay output 59. Relay output 59 applies said audible tactical emergency alert message to the said broadcast radio receiver's loudspeaker (not shown). Therefore, the present invention temporarily interrupts the said broadcast radio receiver's normal audio output to play the said audio tactical emergency alert messages. Thus, the present invention has the advantage, without limitation, of simple integration with legacy broadcast radio receivers. The only modification required is to reroute the legacy broadcast radio receiver's audio output and loudspeaker wires through said relay 55. Another advantage of this arrangement is that the tactical emergency alert messages will be played even if the host broadcast radio is powered off Another advantage is that the system provides a level of interoperability among emergency services. Each emergency service can be the source of tactical emergency alert messages. And if emergency vehicles are outfitted with alert receiver modules 50, the passengers can hear messages from other services. Yet another advantage attending the use of ad hoc (non-canned) messages is that the messages can be fine-tuned to the specific situation. (“Pull over red Ford truck.”) Another advantage is that the emergency message is played within the vehicle, alleviating the difficulty of hearing and discerning the direction from which a siren is coming and the drivers' tendency to ignore sirens until very late. As will be shown below, for hard-of-hearing drivers, the present invention provides text and alert lights to capture the drivers' attention. Canned messages may have multiple language versions. A driver may select a language of choice in the receiver; a canned message will be played in the selected language upon receipt.

As will be apparent to one skilled in the radio art, there are many similar arrangements possible and are anticipated herein. For example, the functionality of relay 55 can be incorporated into future broadcast radio receivers, so that control signal bundle 57 and audio signal bundle 58 could thereby be directly attached to the future broadcast radio receiver. Similarly, the present invention could fully integrated into future mobile, portable and fixed broadcast radio receivers and portable broadcast radio receivers, and special purpose mobile, portable and fixed receivers.

Still referring to FIG. 3, the present invention further includes LED display 60 and display control bundle 62. Message decoder 54 further discerns text tactical emergency alert messages (not shown) from digital RF receiver 52. Message decoder 54 discernibly sends text tactical emergency alert messages to controller 56. Controller 56 displays said text tactical emergency alert messages on LED display 60 using display control bundle 62. LED display 60 may further include indicator lights (not shown) or an audible tone generator (not shown) to capture the attention of passengers when text is displayed. Thus the present invention has the advantage, without limitation, of playing textual and audio tactical emergency alert messages simultaneously.

As will be apparent to one skilled in the radio art, there are many similar arrangements possible and are anticipated herein. For example, the functionality of LED 60 can be incorporated into future broadcast radio receivers, so that display control bundle 62 could thereby be directly attached to the future broadcast radio receiver. Similarly, the present invention could, in its entirety, be integrated into future mobile, portable and fixed broadcast radio receivers and portable broadcast radio receivers, and special purpose mobile, portable and fixed receivers.

Still referring to FIG. 3, said canned text and canned audio messages are represented in multiple languages. The operator of alert receiver module 50 may select the language of choice through a configuration dialog using, in a non-limiting example, LED display 60, controller 56 and one or more hard or soft selection buttons (not shown).

Still referring to FIG. 3, in another embodiment of the present invention, digital receiver 52 is a transceiver. This added transmitter functionality enables two-way management functions, such as the non-limiting example of the uploading of new firmware or software over the air. Similarly, said canned messages may be uploaded over the air for corrections, improvements and additions to the said canned messages. Uploading of canned messages and firmware may be done via direct connection to the alert receiver module 50 via Ethernet, USB connections and similar interfaces, as will be understood by one skilled in the art. As will be show below, having two-way communications enables more robust networking protocols, such as ad hoc networking and cognitive radio networking.

Still referring to FIG. 3, in another embodiment of the present invention, digital receiver 52 has a plurality of receivers so that digital receiver 52 may simultaneously receive messages from a plurality of sources and play out completed messages serially, in a non-limiting example, in order of first completed, or by first sent according to a timestamp within said messages, or by priority, or by the source's organization, such as fire, police or ambulance. Thus if, for example, two or more emergency vehicles are approaching the same incident location, alert receiver module 50 may receive messages from each approaching vehicle. As shown herein, an embodiment of the present invention enables the transmitting sources to select a channel that is not already in use, so that multiple channels may be used.

In broad embodiment, the present invention is an alert system for passenger vehicles that may be approaching an area in which immediate danger is especially prevalent due to very recent events (tactical situations), such as incidents typically responded to by first responders, including fire, police and ambulances, and localized weather-related incidents, such as a bridge outage. The present invention also may be used tactically for traffic boards.

Referring now to FIG. 4a, there is a non-limiting, exemplary illustration of a tactical emergency alert message (message) of the present invention, generally indicated by ‘70.’ Message 70 includes a start of message (SOM) 71 field, a type field 72, a length field 73, a data field 74, a GPS (Global Positioning System) data field 75, a range field 76, and an end of message (EOM) field 77. Type field 72 differentiates between text and audio data contained within data field 74. Length field 73 indicates the length of the entire message 70. Data field 74 may include, in a non-limiting example, ASCII text or AMBE-encoded audio data. GPS data field 75 includes GPS location data of the sending transmitter. Range field 76 indicates the maximum distance between the sending alert transmitter module and the receiving alert receiving module, indicated, in a non-limiting example, by a relative figure (short, medium or long) or a distance in meters. End of message (EOM) 77 indicates the end of message 70. The present invention anticipates other proprietary encodings of message 70 and the fields thereof, and the use of standard framing message formats such as HDLC, as will be understood by one skilled in the art. Also anticipated is the encapsulation of message 70 encodings within the TCP/UDP/IP family of Internet protocols and other standard protocols.

Referring now to FIG. 4b, there is a non-limiting, exemplary illustration of the encoding of the tactical emergency alert message of FIG. 4a within the data field of a standard Emergency Alert Message. Referring to FIG. 4b, escape code 182 indicates that the data field of an Emergency Alert Message contains non-standard data. The T-EAM field includes the message format of FIG. 4a. In FIG. 4b, escape code 2 field 186 indicates the end of the data field of an Emergency Alert Message. As will be understood by one skilled in the art, many other encodings will be apparent and are anticipated by the present invention. Also anticipated is a standards committee-determined protocol to transport tactical emergency alert messages within Emergency Alert System messages or other standard protocols.

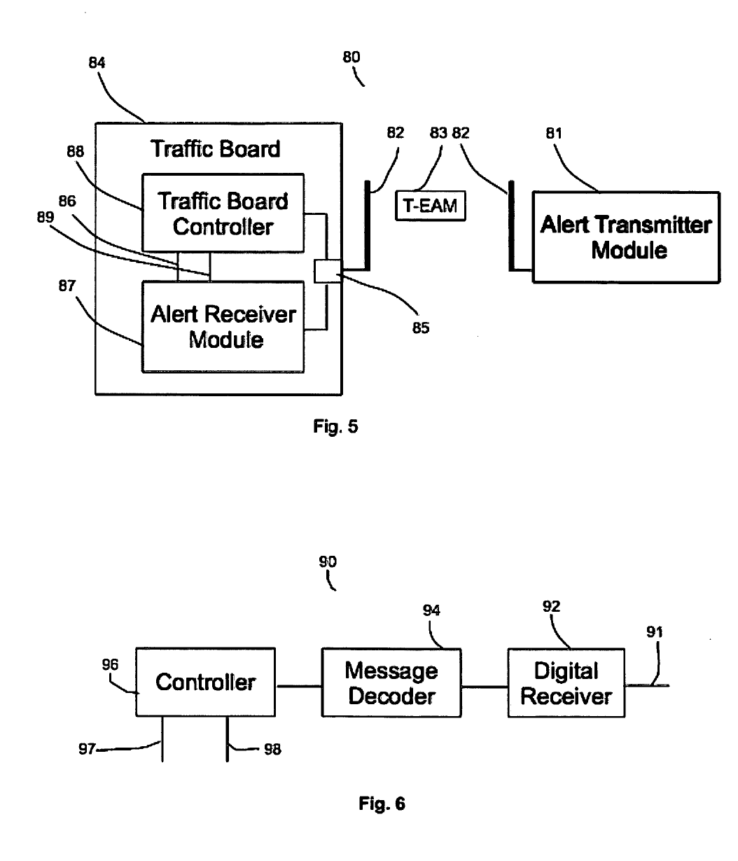

Referring now to the invention of FIG. 5, there is an invention, generally indicated by ‘80’, similar to the invention of FIG. 1, except that alert receiver module 87 is installed upon or within a traffic board 84. Traffic board 84 is a sign with changeable text deployed generally on major highways to provide drivers with information concerning safety or driving convenience. Traffic boards 84 generally provide more localized information than national, regional, county or city emergency alert systems, but the addition of an alert receiver module 87 to traffic boards 84 enables first responders to override or supplement traffic board text with tactical emergency alert messages 83 using an alert transmitter module 81 typically deployed in a first responder vehicle (not shown).

Still referring to FIG. 5, alert transmitter module 81 transmits via antenna 82 tactical emergency alert messages 82 to traffic board 84. Within traffic board 84, alert receiver module 87 receives said tactical emergency alert message 83 via antenna 82 and receive RF signal divider 85. Alert receiver module 87 sends tactical emergency alert message 83 to traffic board controller 88 using control signal bundle 86 and a message signal bundle 89. The use of receive RF signal divider 85 assumes that traffic board 84 uses an RF signal for its control and that the RF band for controlling traffic board 84 is the same as the RF band for alert transmitter module 81. If the RF band differs for traffic board 84 and alert transmitter module 81, then alert receiver module 87 will have a separate antenna 82 and will need no receive RF signal divider 85, as will be understood by one skilled in the radio art.

Refer to the description of FIG. 2 for a description of alert transmitter module 81.

Refer to FIG. 6 for a description of the alert receiver module 87 of FIG. 5. Referring now to FIG. 6, the LED display and related controls of FIG. 3 have been removed from FIG. 6 since a traffic board is itself a text display system. The relay and associated controls of FIG. 3 have been removed since traffic boards generally do not have loudspeaker systems; refer to the description of FIG. 3 for traffic boards with sound systems.

Referring again to FIG. 6, there is an alert receiver module 90 with a RF digital receiver 92 receiving an RF signal (not shown) over an RF signal line 91 from an RF signal splitter (not shown) or antenna (not shown). Digital receiver 92 demodulates the RF signal and provides, in the present example, a demodulated digital text signal stream therefrom to message decoder 94. Message decoder 94 decodes text tactical emergency alert messages (not shown) from said demodulated digital signal stream and sends said text tactical emergency alert messages to controller 96. Controller 96 sends said text tactical emergency alert messages to a traffic board controller (not shown) using text message control bundle 97 and text message signal bundle 98. Text message control bundle 97 and text message signal bundle 98 will differ for each traffic board vendor and model, as will be understood by one skilled in the communications art. In another embodiment of the present invention, alert receiver module 90 is fully integrated into a traffic board system (not shown). In another embodiment of the present invention, a standard communications mechanism for communicating messages between an alert receiver module 90 and a traffic board will be a serialized tactical emergency alert message of FIG. 4 over an RS-485, Ethernet or other communications standard.

In broad embodiment, the present invention is a tactical alert system for passenger vehicles traveling on major roads that have traffic boards.

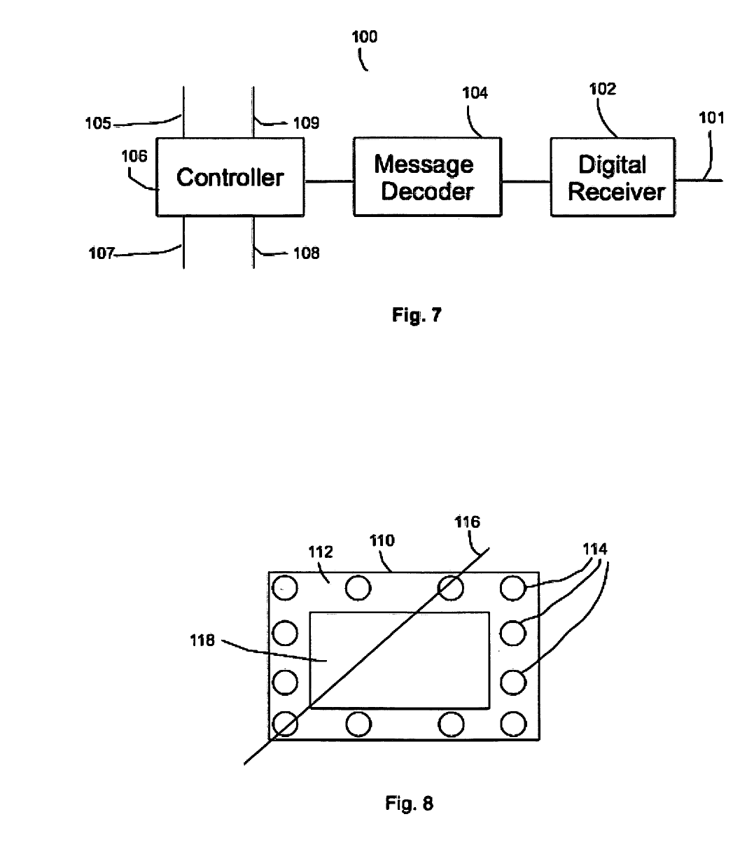

Referring now to FIG. 7, there is an alert receiver module 100 that is similar to the alert receiver module of FIG. 3 and FIG. 6 except that alert receiver module 100 is configured for use as an embedded module within, for example, a general AM/FM mobile broadcast receiver (host device, not shown) used in a passenger vehicle. The LED display of FIG. 3 has been removed from FIG. 7 since the embedded alert receiver module 100 of FIG. 7 relies on a text screen shared with the host device in which said alert receiver module 100 is embedded.

Referring again to FIG. 7, there is an alert receiver module 100 with an RF digital receiver 102 receiving an RF signal (not shown) over an RF signal line 101 from an RF signal splitter (not shown) or similar arrangement well know to one skilled in the art for sharing a common antenna with said AM/FM mobile broadcast receiver in the present example. Digital receiver 102 demodulates said RF signal and provides, in the present example, a demodulated digital signal stream which is communicated to message decoder 104. Message decoder 104 decodes text tactical emergency alert messages (not shown) from said demodulated digital signal stream and sends said text tactical emergency alert messages to controller 106. Controller 106 presents said text tactical emergency alert messages to said embedded host (not shown) using text message control bundle 107 and text message signal bundle 108. In the preferred embodiment, text message control bundle 107 and text message signal bundle 108 control access to memory registers (not shown) shared between alert receiver module 100 and the embedded host (not shown). Many such arrangements are well understood by one skilled in the art. For example, text message control bundle 107 and text message signal bundle 108 could alternatively control a serial interface between alert receiver module 100 and the embedded host (not shown).

Still referring to FIG. 7, message decoder 104 may also decode audio tactical emergency alert messages (not shown) from said demodulated digital signal stream and send said audio tactical emergency alert messages to controller 106. Controller 106 presents said audio tactical emergency alert messages to said embedded host (not shown) using audio message control bundle 105 and audio message signal bundle 109. In the preferred embodiment, audio message control bundle 105 and audio message signal bundle 109 control access to memory registers (not shown) shared between alert receiver module 100 and said embedded host. Many such arrangements are well understood by one skilled in the art. For example, audio message control bundle 105 and audio message signal bundle 109 could alternatively control a serial interface between alert receiver module 100 and said embedded host.

In another embodiment of the present invention, audio message control bundle 105, audio message signal bundle 109, text message control bundle 107 and text message signal bundle 108 may be combined into a single control bundle.

In broad embodiment, the present invention is a tactical alert system module which may be embedded in mobile, portable and fixed broadcast receivers and mobile, portable and fixed transceivers.

Referring now to FIG. 8, there is an alert receiver assembly 110 which includes the remote receiver module (not shown) of FIG. 3. In FIG. 8, mobile receiver assembly 110 has a bezel 112 which holds a plurality of LEDs 114. Only three of the LEDs are marked with ‘114’ for clarity of the illustration. Display 118 is a text display used to display tactical emergency alert messages (not shown). Line 116 is not part of the assembly. Line 116 represents the inference that an observer may make about the direction from which the source (not shown) of a said tactical emergency alert message last received if the two LEDs 114 that line 116 intersects are lit. The direction may be further clarified, for example, if one of the two said LEDs 114 intersected by line 116 blinks to represent the source of the tactical emergency alert message. Alert receiver assembly 110 may determine which two LEDs 114 to light from a GPS within the alert receiver module of FIG. 3 and the GPS data included in the tactical emergency alert message from the source of the message. Thus, the driver (not shown) observing the present invention may roughly determine the direction of the said last tactical emergency alert message received, relative to the receiver of said tactical emergency alert message. This directional clue mitigates the common problem of hearing an emergency vehicle's siren without being able to discern the direction from which it is coming. Similarly, if LEDs 114 are multicolored, a color may be used to indicate some urgency. For example, said urgency could represent the nearness of the source of a message to a receiver of a message, based on the respective GPS data of said source and receiver of said message. As a non-limiting example, green could represent “approaching,” yellow could represent “within several hundred feet,” and red could represent “within several car lengths.”

Similarly, if text display 118 of FIG. 8 is a graphical display, then line 116 may be graphed on display 118.

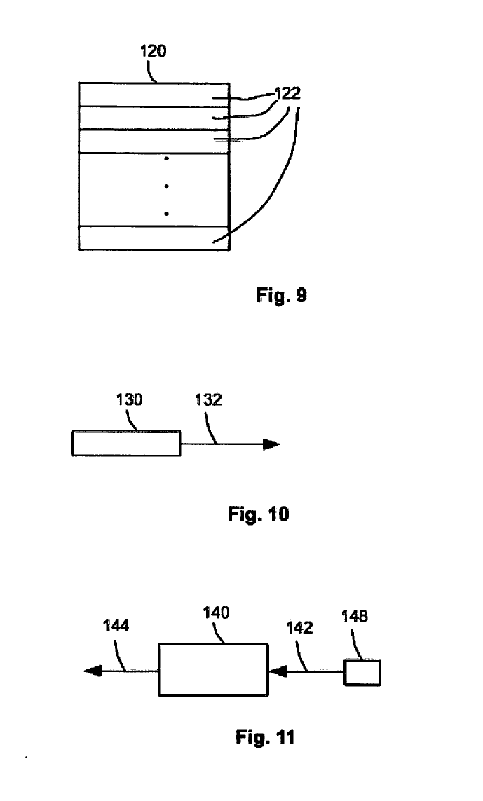

Referring now to FIG. 9, there is an illustration of an agile frequency embodiment of the present invention. Channel block 120 is a set of one to n frequency channels 122 made available to an emergency alert message system (not shown) of FIG. 1, FIG. 2 and FIG. 3. The alert transmitter module 11 of FIG. 1 and alert transmitter module 30 FIG. 2 (transmitter), having a tactical emergency alert message (message) to transmit, will scan channel block 120 of FIG. 9 repeatedly until an available channel 122 is available.

Referring to FIG. 9 in the preferred embodiment, a channel 122 is available if no radio frequency energy above a power-level threshold is detected on channel 122. Once an available channel 122 is detected, the said transmitter may then transmit a message (not shown) in the said available channel 122.

Still referring to FIG. 9, the alert receiver module 50 FIG. 3 (receiver) similarly scans the channel block 120 of FIG. 9 until a busy channel 122 is found containing the beginning (typically the preamble) of a tactical emergency alert message. The said receiver then dwells on the said busy channel 122 of FIG. 9 to detect the remainder of said tactical emergency alert message.

By this method of using multiple channels, represented by channel block 120, the public tactical alert system of the present invention supports increased message traffic in a local area and lessens interference among overlapping areas of tactical messaging.

Still referring to FIG. 9, in another embodiment of the present invention, a said receiver may scan all channels 122 of channel block 120 simultaneously through the use of a multiple-channel FFT (Fast Fourier Transform) circuit, as will be understood by one skilled in the radio art. Scanning all channels 122 simultaneously reduces the problem of missing the beginning of a tactical alert message due to the delay associated with scanning, as will be well-understood by one skilled in the radio art.

Still referring to FIG. 9, in another embodiment of the present invention, channel block 120 is a frequency band or sub-band that, by regulation, is a secondary-use band, such as the 217-220 MHz band in the United States. As will be understood by one skilled in the radio art, a secondary use band provides primary licenses for channels within the band that give a primary licensee a right to use said primary-licensed channels without interference, and provides secondary licenses that give secondary-use licensees the right to use any channel within the said band on a non-interfering basis (with respect to primary licensees). Thus, by the scanning methods described in the description of FIG. 9, the embodiments of the present invention of FIG. 1 to FIG. 8 may operate in a secondary-use manner, avoiding interfering with other primary-use and secondary-use users.

Still referring to FIG. 9, in another embodiment of the present invention, channel block 120 is a radio frequency band in which single carrier or multicarrier cognitive radios, whitespace radios or dynamic spectrum access radios are permitted to operate. Cognitive radios, whitespace radios and dynamic spectrum access radios (generally referred to as “cognitive radios”) are well known to those skilled in the art and are anticipated by the embodiments of the present invention of FIG. 1 to FIG. 8. Thus, the inventions described in FIG. 1 to FIG. 9 may use a single preassigned radio frequency channel (channel), select one or more channels from a set of preassigned channels, select one or more channels from a set of preassigned channels on a non-interfering basis in a band having primary licensees and secondary licensees, or cognitively select one or more channels from a radio frequency band. Similarly, prior to selection of one or more channels, the network radio frequency band may be discovered using ad hoc networking protocols, as will be understood by one skilled in the radio art.

In broad embodiment, the present invention is a single or multi-channel tactical alert message system.

Referring now to FIG. 10, there is a vehicle 130 having therein the emergency transmitter module (not shown) of FIG. 2, which includes a GPS receiver (not shown). Referring again to FIG. 10, vehicle 130 is traveling in a direction indicated by vector 132 at a speed n, said speed calculated by the message coder/controller of FIG. 3 using the changing location data reported by said GPS receiver, as will be understood by one skilled in the art. Thus the message coder/controller of FIG. 3 can transmit the last tactical emergency alert message (not shown) periodically, where the period between transmissions is inversely proportional to the said speed of vehicle 130; that is, the transmission rate increases as the speed of vehicle 130 increases. The said periodic retransmission relieves the driver of vehicle 130 from the distraction of manually re-sending said last tactical emergency alert message while approaching an incident area, thus increasing the safety of using said emergency transmitter module. Similarly the increase in the rate of automatic retransmission of said last tactical emergency alert message proportionally with speed increases public safety by providing the same density of said last tactical emergency alert messages in a geographical area irrespective of the speed of said vehicle 130.

Referring now to FIG. 11, there is a message filter function 140 within the controller 56 of the alert receiver module of FIG. 3 that accepts or discards messages received from message decoder 54 of FIG. 3. Referring again to FIG. 11, a received tactical alert message (message) 148 is filtered by message filter function 140 according to the rules described below. If filter function 140 accepts a message 148, said message 148 takes path 144 for further processing by controller 56 of FIG. 3 as described in the description of FIG. 3. Referring now to FIG. 11, if filter function 140 rejects a received message 148, said message 148 is discarded.

Still referring to FIG. 11, various rules for accepting and declining received tactical alert messages (messages) may be applied within message filter function 140, as will be understood by one skilled in the communications arts. In a non-limiting example, messages may include a class-of-user field, such as private vehicle, public vehicle, fire, police, emergency medical, sheriff, supervisors, or all first responders. In another non-limiting example, messages may have a geographical area scope (“convergence vector”) such as short, medium, and long distances from the estimated convergence of the transmitting source of a message and the receiver of the message, as calculated from the GPS coordinates of the transmitting emergency alert transmitter 30 of FIG. 2, said GPS coordinates included within the messages, and the GPS coordinates of the receiving emergency alert module 50 of FIG. 3. Referring again to FIG. 11, in a non-limiting example, ‘short’ may refer to a city block, ‘medium’ may refer to four city blocks, and ‘long’ may refer to a neighborhood. As will be understood by one skilled in the communications art, such distances are only approximate.

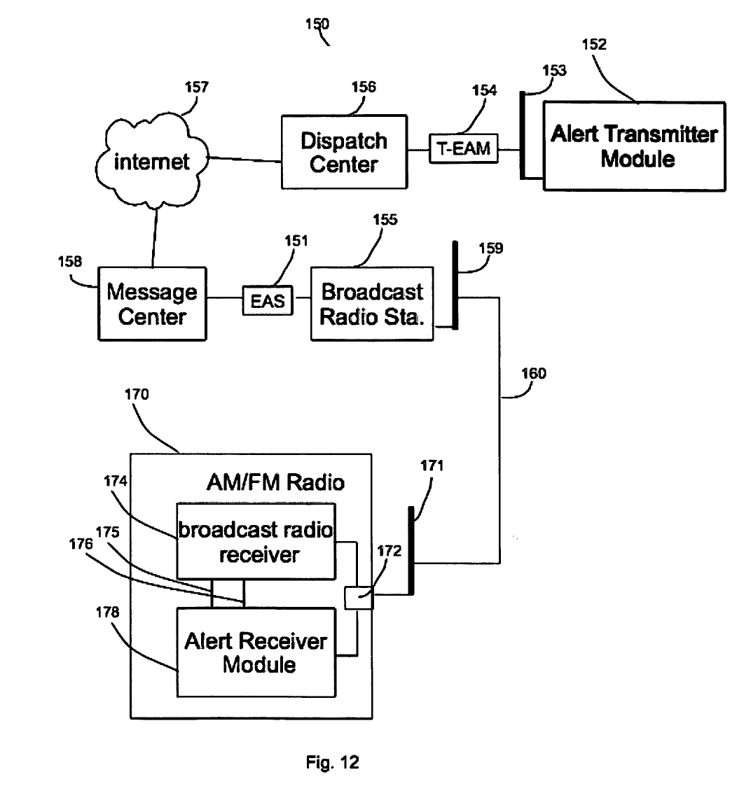

Referring now to FIG. 12, there is an emergency alert system 150 having an alert transmitter module 152 which, in combination with an antenna 153, transmits tactical emergency alert messages (messages) 154 to dispatch center 156, said messages 154 having a tactical message type (not shown), such as tactical text message or tactical digital voice message, GPS coordinates (not shown) and a range figure (not shown) therein. Dispatch center 156 has a receiver (not shown) therein, similar to alert receiver module 178 described below. Dispatch center 156 receives messages 154 and transfers them over an interne 157 to message center 158. Message center 158 formats message 154 within Emergency Alert System message 151 including therein message 154 for transmission over a public broadcast station 155, such as a public FM broadcast station. Public broadcast station 155 transmits Emergency Alert System Message 151 to mobile receiver assembly 170. Mobile receiver assembly 170 is similar to the mobile receiver assembly of FIG. 1.

Referring again to FIG. 12, mobile receiver module 170 is typically within a pubic or private passenger vehicle (not shown). Antenna 171 of mobile receiver assembly 170 captures transmitted Emergency Alert Message 151 and other signals (not shown), such as broadcast AM or FM signals. RF signal splitter 172 splits the signal including Emergency Alert System message 151 and other signals (not shown), sending said signals to broadcast radio receiver 174 and alert receiver module 178. Alert receiver module 178 Emergency Alert Message 151, extracting therefrom message 151. Using control signal bundle 175, alert receiver module 178 interrupts broadcast radio receiver 174 so that it will receive decoded message 151 over message signal bundle 176. Broadcast radio receiver 174 then interrupts any non-emergency signals (not shown) being displayed or played and displays text message 151 on a text display (not shown) on receiver assembly 174 or plays audio message 151 on a sound system (not shown) within receiver assembly 170.

In another embodiment of the present invention, alert transmitter module 152 includes a GPS receiver and includes its GPS location data within tactical emergency alert message 154. Alert receiver module 179 also includes a GPS receiver. When Alert receiver module 178 decodes tactical emergency alert message 154, as described above, alert receiver module 178 compares its GPS location data with said GPS location data within tactical emergency alert message 154. If said comparison is greater than a maximum range, then said tactical emergency alert message 154 will be discarded. Thus, this mechanism provides a filter for messages originating too far from the receiving alert receiver module 178.

In another embodiment of the present invention, alert transmitter module 152 further includes said maximum range within tactical emergency alert message 154, said maximum range determined by the operator (not shown) of alert transmitter module 152 through a human interface mechanism (not shown), for example, a short-, medium- and long-range selector buttons.

As will be understood by one skilled in the radio art, the format of tactical emergency alert message 154 and Emergency Alert System message 151 is exemplary. Standard message formats and proprietary message formats for conveying text and audio data is anticipated by the present invention.

In broad embodiment, the present invention is a tactical alert message system for use over public broadcasting channels.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

1. An emergency alert receiver module for reception of tactical alert messages comprising:
a) a radio receiver for reception of tactical alert messages; and
b) a means for disseminating said tactical alert messages to a message player.

2. The emergency alert receiver module of claim 1 where said message player device is at least one of a broadcast radio receiver with an audio speaker, a broadcast radio receiver with a text display, a broadcast radio receiver with a graphical display, a text display, a graphical display and an audio speaker.

3. An emergency alert transmitter module for transmitting emergency alert messages comprising:
a) an emergency alert message transmitter;
b) an emergency alert message generation means;
c) a message coding means; and
d) a message selection means.

4. The emergency alert transmitter of claim 3 further comprising a frequency selection means.

5. The alert receiver module of claim 1 embedded within a portable, mobile or fixed receiver or transceiver.

6. The emergency alert receiver module of claim 2 further comprising a means to display directional clues about the source of a received tactical message.

7. The emergency alert receiver of claim 1 further comprising a multi-channel means.

8. The emergency alert receiver of claim 1 further comprising a filter function for selecting tactical alert messages for the user of said emergency alert receiver.

9. The filter function of claim 8 where said filter function operates to select tactical alert messages transmitted from at least one of a prescribed geographical scope, a prescribed class of user, and a prescribed tactical message priority.

10. The alert receiver module of claim 1 further comprising a means to receive tactical messages via a public broadcast station.

11. The emergency alert transmitter module of claim 3 further comprising a means for an alert transmitter operator to select a text tactical message for transmission.

12. The emergency alert transmitter module of claim 3 further comprising a means for an alert transmitter operator to select an audible tactical message for transmission.

13. The emergency alert transmitter module of claim 3 further comprising a means for an alert transmitter operator to create a canned tactical message for transmission.

14. The emergency alert transmitter module of claim 3 further comprising a means for an alert transmitter operator to create an ad hoc tactical message for transmission.

15. The emergency alert transmitter module of claim 3 further comprising a means for a user to select the geographical scale associated with tactical messages to be transmitted.

16. The emergency alert transmitter module of claim 3 further comprising a multi-channel means.

17. The emergency alert transmitter module of claim 3 further comprising a means for periodic retransmission of an emergency alert message.

18. The emergency alert transmitter module of claim 3 further comprising a means for operators to selectably override traffic board display text.

19. An emergency alert transmission system for transmission of emergency tactical messages via public broadcast stations comprising:
a) the emergency alert transmitter of claim 3;
b) a dispatch center;
c) a network such as an interne; and
d) a message center for communications with a public broadcast station.

20. An emergency alert system for disseminating emergency tactical messages comprising:
a) a plurality of broadcast radio receivers;
b) a plurality of alert receiver modules coupled respectively to said plurality of broadcast radio receivers; and
c) at least one alert transmitter module.
